(19) United States
(12) Patent Application Publication
(10) Pub. No.: US 2025/0344012 A1
(43) Pub. Date: Nov. 6, 2025

(54) HEADPHONES

(71) Applicant: Sonos, Inc., Goleta, CA (US)

(72) Inventor: Tristan TAYLOR, Boston, MA (US)

(21) Appl. No.: 19/197,806

(22) Filed: May 2, 2025

Related U.S. Application Data
(60) Provisional application No. 63/643,313, filed on May 6, 2024.

(51) Int. Cl. H04R 1/10; H04R 1/02

(52) U.S. Cl. CPC H04R 1/1066; H04R 1/023; H04R 1/1008; H04R 1/105; H04R 1/1083; H04R 2460/01

(57) ABSTRACT

A headphone has a headband, a first earcup, and a second earcup. The headband includes features to enable size adjustments to the headphones and cushions to make the headphones more comfortable to wear. The earcups include earcushions that provide comfort to the users and allow for a slim overall profile for the earcups. The earcups also include port and microphone configurations that provide for a minimalist design and improved active noise cancellation.

### CROSS-REFERENCE TO RELATED APPLICATIONS

This application claims the benefit of and priority to U.S. Provisional Application No. 63/643,313 filed on May 6, 2024, and entitled HEADPHONES, the contents of which are incorporated by reference herein in its entirety.

### FIELD OF THE DISCLOSURE

The disclosure is related to audio playback devices and, more particularly, to systems, methods, features, and other elements directed to headphones.

### BACKGROUND

With ever expanding listening options, including music, podcasts, and audiobooks, the use of audio playback devices has dramatically increased in recent history. Headphones are a particularly popular choice for consuming audio content because they are highly portable. Additionally, headphones allow for users to enjoy a personal listening experience without the audio content bothering or being shared with those around them.

However, with the increased availability and use of headphones, consumers are constantly searching for headphones that provide a more comfortable and higher quality user experience. Accordingly, there continues to be a need to develop headphones that provide an improved user experience.

### BRIEF DESCRIPTION OF THE DRAWINGS

Features, aspects, and advantages of the presently disclosed technology may be better understood concerning the following description, appended claims, and accompanying drawings. A person skilled in the relevant art will understand that the features shown in the drawings are purposes of illustration, and variations, including different or additional features and arrangements thereof, are possible.

FIG. 1 shows a set of headphones according to an example embodiment.

FIG. 2 shows the set of headphones of FIG. 1 with portions of the headband removed.

FIGS. 3A and 3B illustrate a slider mechanism according to an example embodiment.

FIG. 4 shows a headband frame according to an example embodiment.

FIG. 5 shows a headband frame and a cover plate according to an example embodiment.

FIGS. 6 and 7 show a headband frame and cushions according to an example embodiment.

FIG. 8 shows a headband spring according to an example embodiment.

FIGS. 9-11 show an earcushion according to an example embodiment.

FIGS. 12-14 show ports of an earcup according to an example embodiment.

FIG. 15 shows a feedback microphone configuration according to an example embodiment.

The drawings are to illustrate example implementations and are not drawn to scale. It is understood that the inventions are not limited to the arrangements and instrumentalities shown in the drawings.

### DETAILED DESCRIPTION

A better understanding of different embodiments of the disclosure may be had from the following description read with the drawings in which like reference characters refer to like elements.

While the disclosure is susceptible to various modifications and alternative constructions, certain illustrative embodiments are in the drawings and are described below. The dimensions, angles, and curvatures represented are to be understood as examples for purposes of illustration and are not necessarily shown in proportion.

It should be understood, however, there is no intention to limit the disclosure to the specific embodiments disclosed, but on the contrary, the intention covers all modifications, alternative constructions, and equivalents falling within the spirit and scope of the disclosure.

The labels used herein that indicate or suggest particular orientations of components are used for convenience and describe one of many possible configurations.

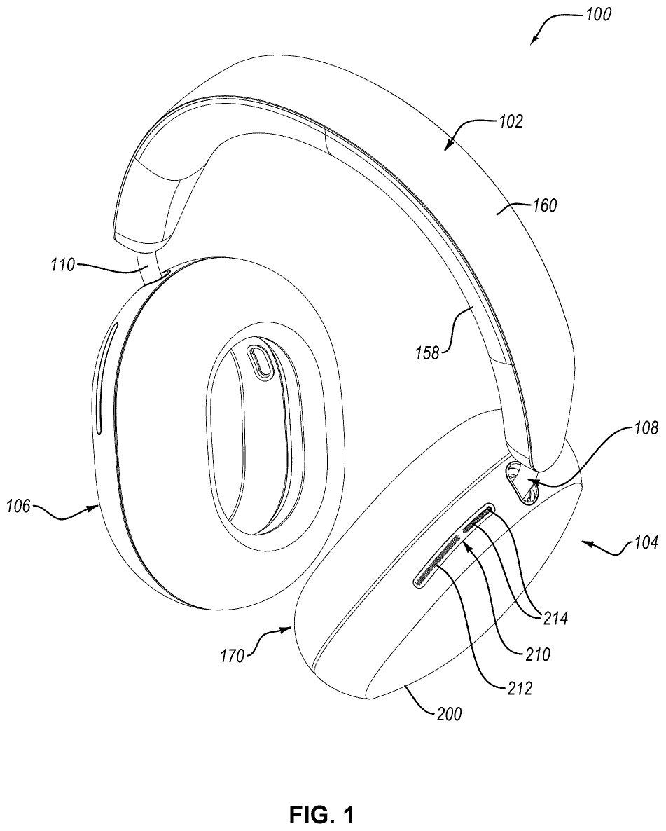

FIG. 1 illustrates an example pair of headphones 100 (also referred to herein as “headphone”). The depicted headphone 100 comprises a headband 102, an earcup 104, and an earcup 106. The headband 102 spans between the two earcups 104, 106 and is connected to the earcups 104, 106 through connecting members 108, 110.

The headphone 100 may comprise one or more transducers within each of the earcups 104, 106. The one or more transducers may comprise speakers and/or microphones. Additionally, the headphone 100 may comprise various other components including, but not limited to, a wireless network interface (e.g., WiFi, Bluetooth, Cellular, etc.), a battery, a user interface, one or more processors, and/or computer-readable storage.

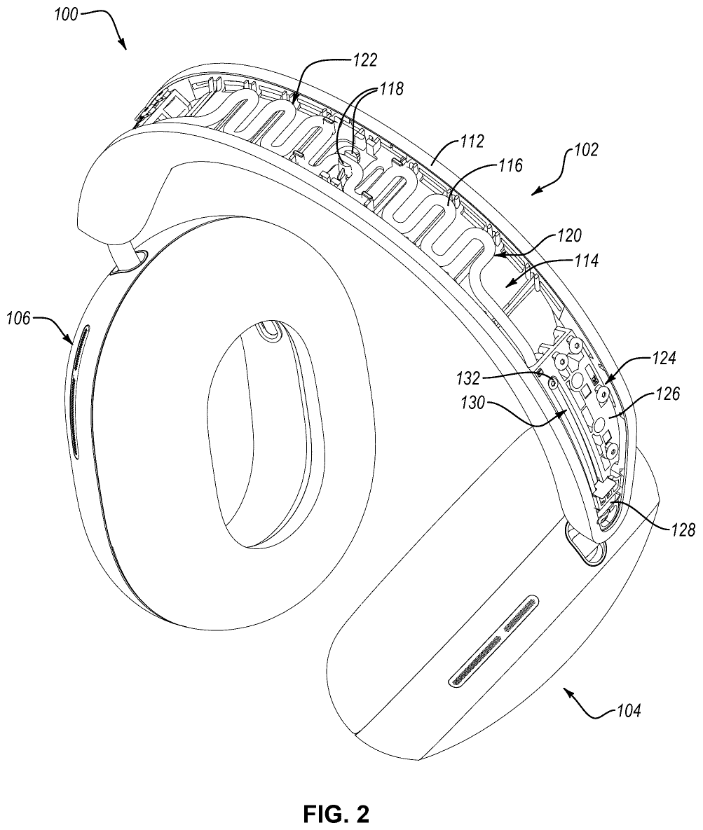

With continued reference to FIG. 1, reference is now also directed to FIGS. 2-8, which illustrate features of the headband 102.

FIG. 2 illustrates the headband 102 with various layers and components removed. As can be seen, the headband 102 includes a frame 112 that provides some of the primary structural aspects to the headband 102. The frame 112 has a curved shape to generally fit over a user's head.

The frame 112 includes a channel 114 in which various components of the headband 102 can be disposed. For instance, as shown in FIG. 2, a cable 116 is disposed within the channel 114. The cable 116 can electrically connect the earcups 104, 106 together to carry electrical power, audio signals, and/or other electrical signals therebetween. In the illustrated embodiment, the middle of the cable 116 is connected to the middle of the frame 112. For instance, the frame 112 includes a retaining feature 118 that secures the middle of the cable 116 in place within the channel 114. The retaining feature 118 may be or include a friction fit feature (e.g., opposing sidewalls that hold the cable 116 therebetween via friction), a clip, adhesive, or any other suitable component or structure capable of holding the middle of the cable 116 in place. In the illustrated embodiment, the retaining feature 118 is disposed in the middle of the frame 112 side-to-side such that the retaining feature 118 is disposed about equidistant from each of the earcups 104, 106. Additionally, the retaining feature 118 is also disposed about midway or centered front-to-back between the front and rear of the frame 112.

Between the retaining feature 118 and each of the connecting members 108, 110, the cable 116 may have a non-linear segment 120, 122. In the illustrated embodiment, the non-linear segments 120, 122 have serpentine configurations, but other configurations are contemplated (sinusoidal, S-shaped, etc.). In some embodiments, the non-linear segments 120, 122 are mirror images of one another. In some embodiments, the portion of the cable 116 that is secured by the retaining feature 118 is offset from maximum amplitudes of the curves in the non-linear segments 120, 122.

The non-linear segments 120, 122 may allow for length of the cable 116 between the retaining feature 118 and the connecting members 108, 110 to selectively expand and contract. For instance, as the earcups 104, 106 are extended relative to the headband 102 (e.g., moved further from the ends of the headband 102 to increase the size of the headphone 100), the length of the cable 116 can expand by at least partially straightening the non-linear segments 120, 122. Conversely, when the earcups 104, 106 are retracted relative to the headband 102 (e.g., moved closer to the ends of the headband 102 to decrease the size of the headphone 100), the length of the cable 116 can be shortened by returning to the non-linear configuration. To facilitate the return to the non-linear configuration, the cable 116 may be formed to have a memory of the non-linear configuration. This may be done by forming the cable 116 from shape memory materials (metals, plastics, etc.) or by heat setting the cable 116 in the non-linear configuration.

FIG. 2 also illustrates a slider mechanism 124 disposed adjacent to an end of the headband 102. The slider mechanism 124 facilitates the extension and retraction of the earcup 104 relative to the headband 102. A similar slider mechanism may also be disposed at the opposite end of the headband 102 to facilitate the extension and retraction of the earcup 106 relative to the headband 102. As can be seen in FIG. 2, the slider mechanism 124 includes a housing 126 that is mounted within the channel 114 of the frame 112. The housing 126 may be secured to the frame 112 with a fastener 128, such as a pin, clip, bolts, screws, adhesive, or other suitable mechanical.

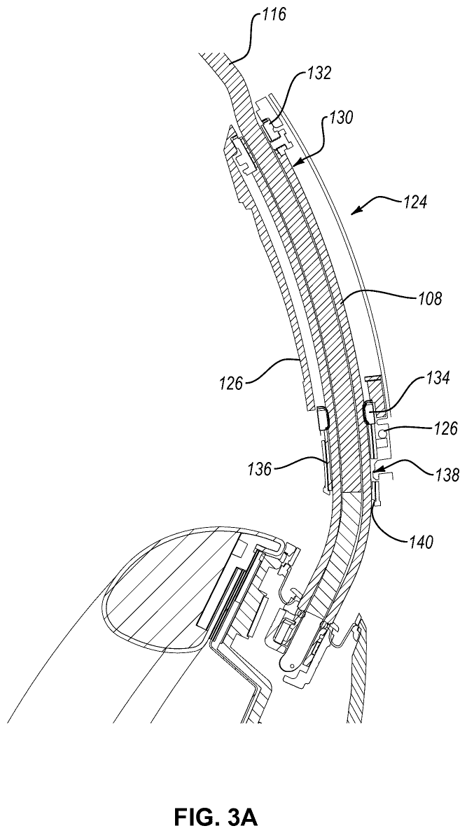

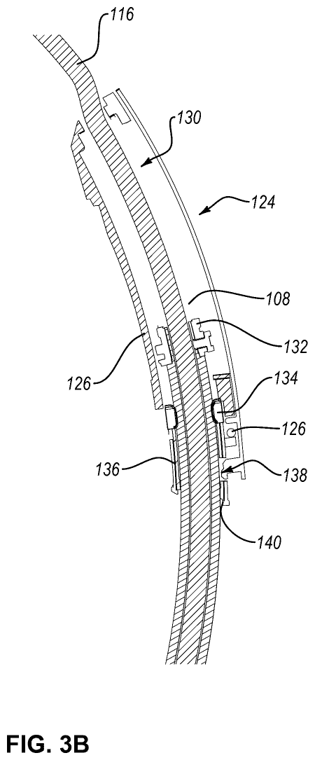

With continued attention to FIG. 2, attention is now also directed to FIGS. 3A and 3B, which illustrate the connecting member 108 and the earcup 104 in retracted and extended positions, respectively, with additional details of the slider mechanism 124 shown. In FIGS. 3A and 3B, the slider mechanism 124 is shown in cross-section. For simplicity, some additional components (e.g., the earcup 104, the cable 116, the connecting member 108) of the headphone 100 have been included, while other components (e.g., the frame 112) have been omitted. Additionally, while the discussion of FIGS. 3A and 3B focus on the slider mechanism 124 associated with the earcup 104, it will be appreciated that the slider mechanism associated with the earcup 106 may be similar to or the same as the slider mechanism 124.

As alluded to above, the earcup 104 can be moved closer to or further from the headband 102 in order to adjust the size of the headphone 100. The slider mechanism 124 facilitates this adjustment. As noted, the slider mechanism 124 includes the housing 126. The housing 126 has a channel 130 extending therethrough. The connecting member 108 extends at least partially into the channel 130 and can slide within the channel 130.

The distal end (e.g., the end furthest from the earcup 104) of the connecting member 108 includes a cap 132. As the connecting member 108 slides through the channel 130, the cap 132 likewise slides through the channel 130 with the connecting member 108. The cap 132 may have an outer shape and/or dimension that generally correspond to the shape and/or inner dimension of the channel 130, such that the cap 132 interfaces with the inner surface of the channel 130 as the cap 132 and connecting member 108 slide through the channel 130. In some embodiments, in contrast, the connecting member 108 may have an outer dimension that is smaller than the outer dimension of the cap 132 and the inner dimension of the channel 130. As a result, the outer surface of the connecting member 108 may not touch or interact with the inner surface of the channel 130. This configuration may reduce the friction associated with sliding the connecting member 108 and the cap 132 through the channel 130.

A grommet 134 may be disposed within the channel 130. In the illustrated embodiment, the grommet 134 is disposed near the lower end of the channel 130 (e.g., the end closest to the earcup 104). The grommet 134 may have a smaller inner dimension than the channel 130 and may engage the outer surface of the connecting member 108. The interface between the grommet 134 and the outer surface of the connecting member 108 may create sufficient friction to hold the connecting member 108 (and the associated earcup 104) in a desired position relative to the headband 102 and prevent the connecting member 108 from undesirably sliding relative to the headband 102. At the same time, the friction between the grommet 134 and the connecting member 108 may be low enough to allow a user to readily overcome the friction in order to adjust the size of the headphone 100 by sliding the connecting member 108 through the grommet 134.

As noted above, the cap 132 may have an outer dimension that is larger than the outer dimension of the connecting member 108. The larger outer dimension of the cap 132 may allow the cap 132 to also function as a stop member. More specifically, the cap 132 may interact with one or more surfaces within the channel 130 to limit the sliding motion of the connecting member 108. For instance, the cap 132 may interact with a shoulder near the upper end of the channel 130 to limit how far the connecting member 108 can be slid into the housing 126. Similarly, the cap 132 may interact with the grommet 134 or a shoulder near the lower end of the channel 130 to limit how far out of the of housing 126 the connecting member 108 can be slid.

The slider mechanism 124 may also include a bushing 136 below the housing 126. The bushing 136 may include a channel 138 therethrough and through which the connecting member 108 can slide. The bushing 136 may have one or more ribs 140 that extend radially inward and interface with the connecting member 108. In some embodiments, the ribs 140 are flexible.

The interfaces between the cap 132 and the interior of the channel 130, the connecting member 108 and the grommet 134, and the connecting member 108 and the ribs 140 of the bushing 136 can provide for desired characteristics. For instance, the noted interfaces can be relatively small, thereby reducing the friction between the components, and thus the amount of force required to adjust the size of the headphone 100. Additionally, having multiple interfaces, and particularly ones that are spread apart, can allow for a very smooth sliding motion between the connecting member 108 and the headband 102. This can provide the headphone 100 with a pleasant user experience and premium feel.

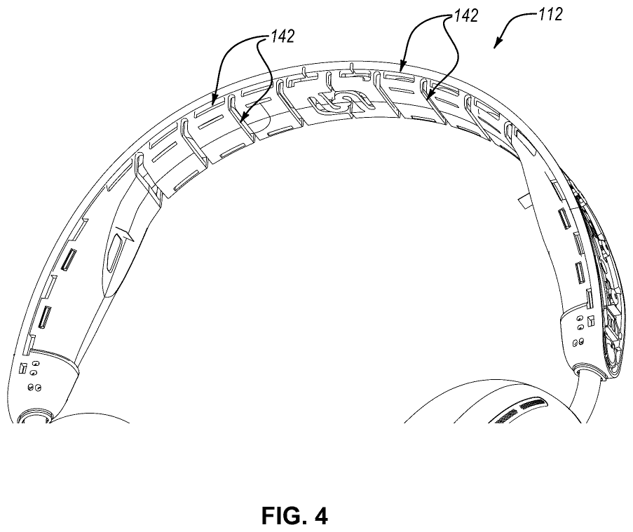

Attention is now directed to FIG. 4, which illustrates another view of the frame 112 of the headband 102. As can be seen, the frame 112 includes a plurality of cutouts 142. Some of the cutouts 142 extend at least partially between the front and rear of the frame 112, while others extend laterally across the portions of the frame 112. The cutouts 142 provide the frame 112 with flexibility. More specifically, because the headphone 100 may be worn by users having different sized heads, the curvature of the headband 102 can be flexible to accommodate such differences. The cutouts 142 allow for the headband 102 to flex larger or smaller without the frame 112 crimping.

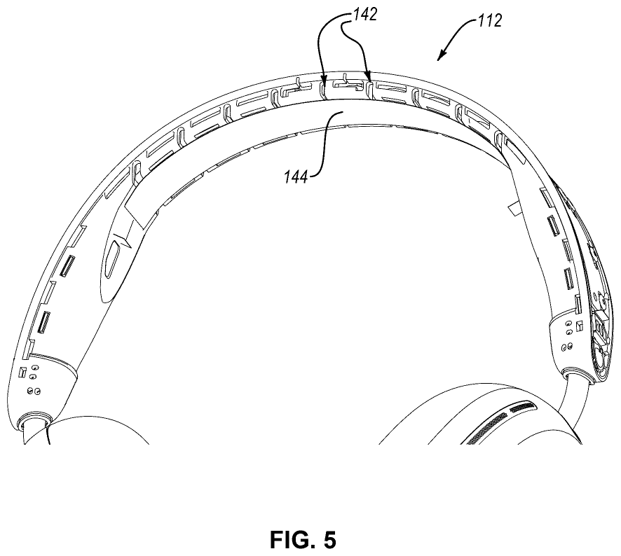

To limit or prevent the cutouts 142 from being felt or seen in the final product (FIG. 1), a cover plate may be positioned to cover all or some of the cutouts 142. For instance, FIG. 5 illustrates an example cover plate 144 that is disposed on the bottom side of the frame 112 and covers portions of the cutouts 142. The cover plate 144 may be formed of any suitable material, such as plastic, metal, or the like. A portion of the cover plate 144 may be attached to the frame 112 while the remainder of the cover plate 144 remain unattached from the frame 112. For instance, a middle region of the cover plate 144 may be attached to the frame 112 (e.g., with a fastener, adhesive, etc.), while the opposing ends of the cover plate 144 are not attached to the frame 112. Connecting only a portion of the cover plate 144 to the frame 112 may allow for the frame 112 to flex without the cover plate 144 hindering such movement.

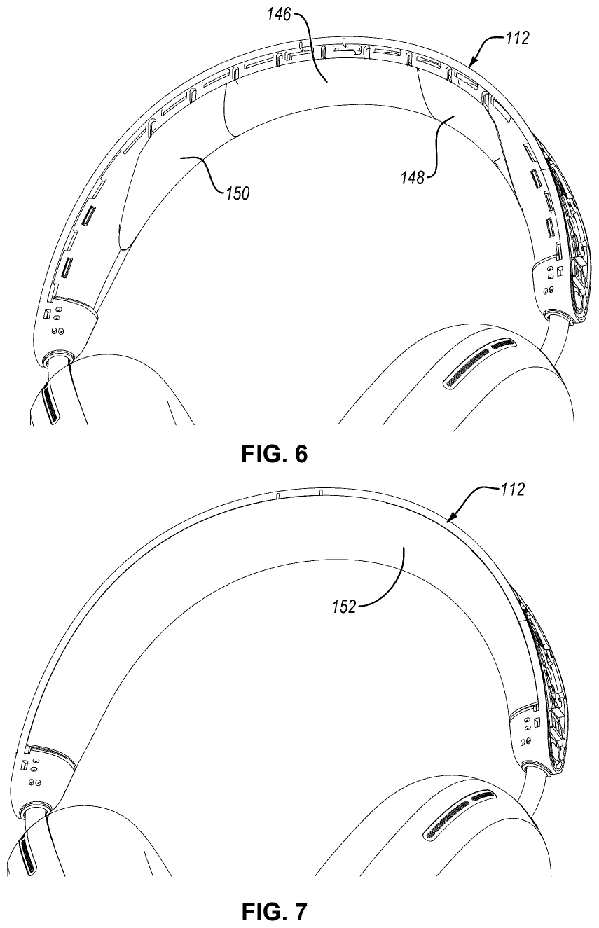

As shown in FIG. 6, the underside of the frame 112 may be at least partially covered with a cushioning material, such as foam. The cushioning material may make the headphone 100 more comfortable to wear. In the illustrated embodiment, there are three cushions 146, 148, 150 attached to the frame 112. The cushion 146 covers the center region of the frame 112, while the cushions 148, 150 are disposed on opposite sides of the cushion 146. In some embodiments, the cushion 146 is formed of a softer material (e.g., open cell foam) than the cushions 148, 150. This may be desirable as the tops of people's head are more sensitive, while the sides are less sensitive and can more comfortably carry the weight of the headphone 100.

The cushions 146, 148, 150 and additional portions of the frame 112 can be covered by an additional cushion 152, as shown in FIG. 7. The cushion 152 may be a relatively thin (e.g., 1 mm, 2 mm, 3 mm, 4 mm, 5 mm) layer of foam. The cushion 152 may soften or smooth out the transitions between the frame 112 and cushions 146, 148, 150, so that the transitions are not or are less visible in the final product (FIG. 1).

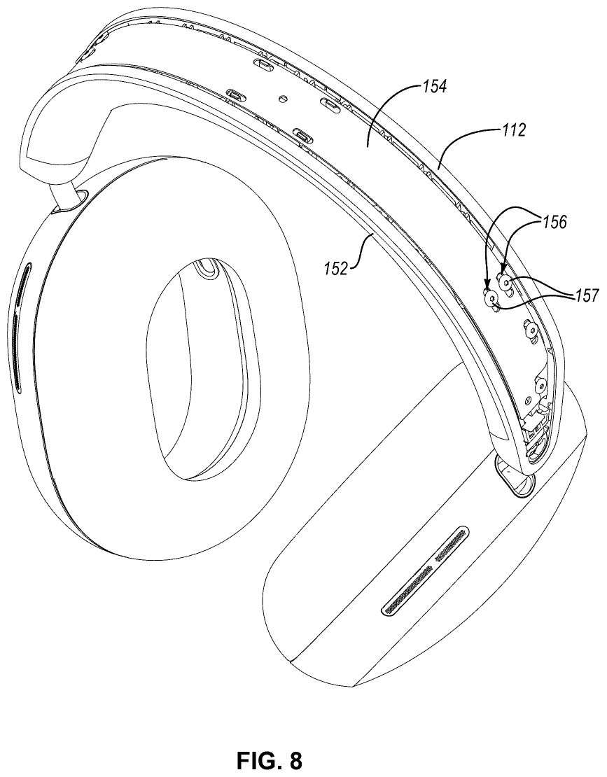

FIG. 8 illustrates a headband spring 154 disposed within the channel 114 of the frame 112. The headband spring 154 can be formed of a metal or semirigid plastic. The headband spring 154 can provide additional structure to the headband 102 and can control the clamping force of the headphone 100 (e.g., how tightly they hold onto a user's head). The headband spring 154 can include slots 156 therethrough. The slots 156 can receive fasteners 157 (e.g., screws, bolts, pins, etc.) that connect the headband spring 154 to the frame 112. The slots 156 may allow for relative movement between the headband spring 154 and the fasteners 157/frame 112 as the headband 102 flexes.

As shown in FIG. 1, the headband 102 may also include one or more outer covers 158, 160. The cover 158 may be a pliable material (e.g., leather, fabric, polyurethane, etc.) that is comfortable in contact with a user's head. The cover 160 may similarly be made of a pliable material. Alternatively, the cover 160 may be a more rigid material, such as plastic or metal.

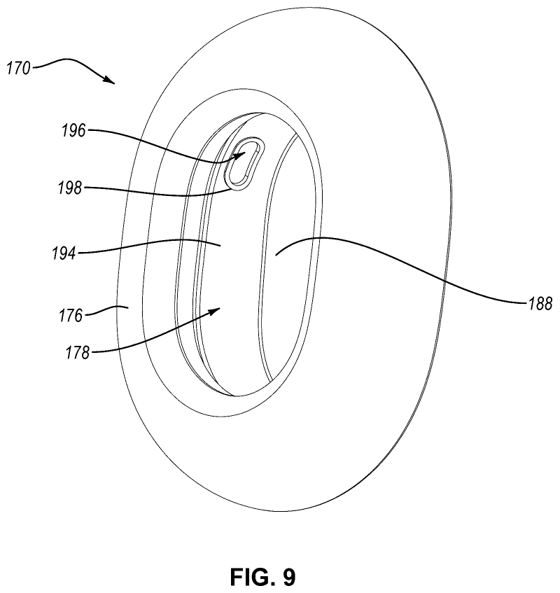

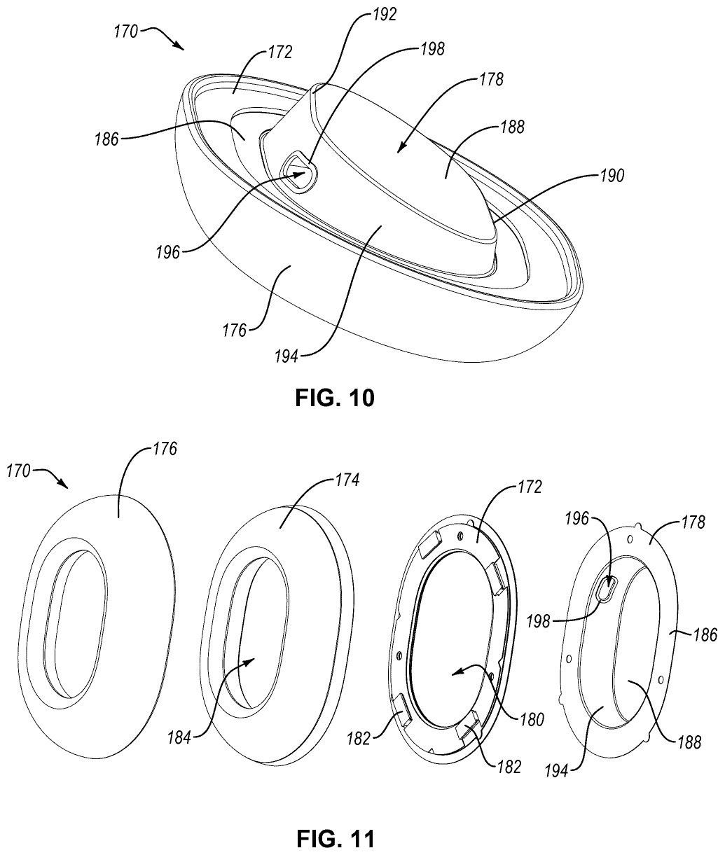

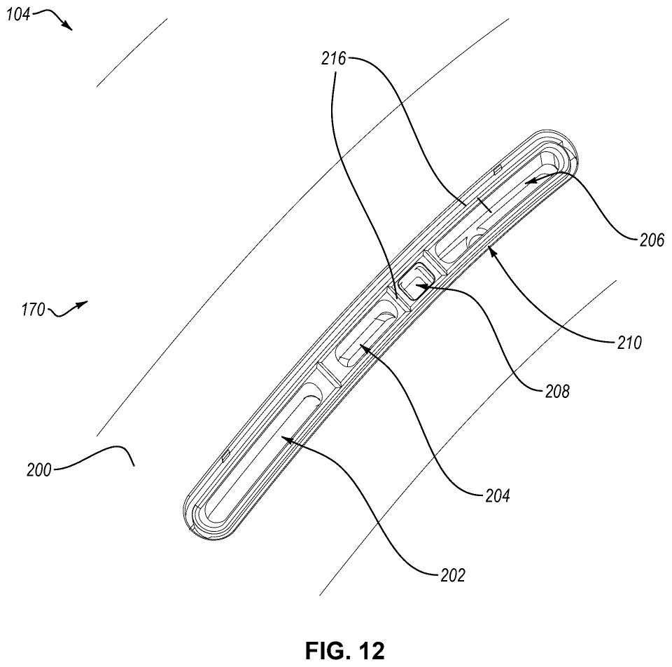

Attention is now directed to FIGS. 9-11, which illustrate aspects of an earcushion 170 of headphone 100. The illustrated earcushion 170 may be part of earcup 104 (FIG. 1). It will be appreciated that earcup 106 may include a similar or identical earcushion. FIGS. 9 and 10 illustrate different perspective views of the earcushion 170 and FIG. 11 illustrates a partially exploded view thereof. Generally, the earcushion 170 includes a frame assembly 172, a cushion 174, a cover 176, and a mesh cage 178.

The frame assembly 172 provides much of the structure to the earcushion 170. The frame assembly 172 has a generally oval or obround shape, although other shapes are contemplated herein. The frame assembly 172 has an aperture 180 extending therethrough. The frame assembly 172 also comprises one or more connection elements 182 that may be used to connect the earcushion 170 to the rest of the earcup 104. In the illustrated embodiment, the one or more connection elements 182 comprise magnets. However, in other embodiments, the connection elements 182 may include any other suitable structures (e.g., hooks, dovetails, clips, etc.) for connecting the earcushion 170 to the rest of the earcup 104.

The cushion 174 is posed on the side of the frame assembly 172 that faces the user's head. As with the frame assembly 172, the cushion 174 has a generally oval or obround shape with an aperture 184 extending therethrough. The apertures 180, 184 may be generally aligned with one another. The cushion 174 may provide a level of comfort when the headphone 100 is worn by the user. The cushion 174 may be made from a variety of materials, including foams. In one embodiment, the cushion 174 is formed from a CFNT foam.

The cover 176 covers the cushion 174 and at least part of the frame assembly 172. The cover 176 may be formed of fabric, leather, polyurethane, or the like. In some embodiments, the cover 176 is formed of the same material as the cover 158.

The mesh cage 178 may be connected to the frame assembly 172. The mesh cage 178 is primarily designed to act as a cover for the components (e.g., transducers, batteries, etc.) within the earcup 104. For instance, the mesh cage 178 can cover the internal components of the earcup 104 so they are not seen through the apertures 180, 184. Additionally, the mesh cage 178 can also limit or prevent water, dust, or debris from entering the interior of the earcup 104.

In some embodiments, the mesh cage 178 is formed of a mesh material that is thermoformed into the desired shape. The mesh may be flexible and resilient such that it can be moved and return to its preformed shape. Additionally, the mesh may be substantially transparent to sound waves, such that sound from a transducer in the earcup 104 can pass through the mesh with minimal distortion or degradation.

As can be seen in FIG. 11, the mesh cage 178 includes a generally planar portion 186 that attaches to the frame assembly 172. The generally planar portion 186 has a generally oval or obround shape. The mesh cage 178 also includes a recessed portion that is defined by a second generally planar portion and a wall 194. The wall 194 extends between and connects the generally planar portion 186 and the second generally planar portion 188.

The second generally planar portion 188 is offset from the generally planar portion 186. Additionally, the second generally planar portion 188 is oriented within a plane that is non-parallel to the generally planar portion 186. As a result, a first part 190 of the second generally planar portion 188 is positioned closer to the generally planar portion 186 than a second part 192 of the second generally planar portion 188. The angled orientation of the second generally planar portion 188 relative to the generally planar portion 186 may provide additional room within the earcup 104 for electrical components without having to increase the overall size of the earcup 104.

In the illustrated embodiment, the mesh cage 178 includes an opening 196 therethrough. The opening may have a frame 198 about a perimeter thereof. In the illustrated embodiment, the opening is formed in the wall 194. However, the opening may alternatively be formed in the second generally planar portion 188. The opening 196 may provide for a clear line of sight for an infrared sensor in the earcup 104. The infrared sensor may detect when the earcup 104 is properly positioned on a user's ear.

Attention is again directed to FIG. 1 as well as to FIGS. 12-14. The earcups 104, 106 includes various ports to allow for air and sound waves to travel into and out of the earcups 104, 106 other than through the earcushions. For instance, the earcup 104 may include a housing 200 having a rear leak port 202, a front leak port 204, a first microphone port 206, and a second microphone port 208. It will be appreciated that the specific number, types, ordering/arrangement of the illustrated ports is merely an example. Other embodiments with different numbers, types, and ordering/arrangements of ports are contemplated herein. It will also be appreciated that earcup 106 may include the same, similar, or different ports, or no parts at all.

The rear leak port 202 may be in communication with a rear cavity behind a transducer diaphragm within the earcup 104. Similarly, the front leak port 204 may be in fluid communication with a front cavity in front of the transducer diaphragm. The rear leak port 202 and the front leak port 204 may allow some of the air within the rear and front cavities to escape therefrom as the transducer diaphragm vibrates to produce sound. The inclusion of the rear and front leak ports 202, 204 may allow for the transducer diaphragm to vibrate more freely or to higher amplitudes without having to increase the power supplied to the transducer as would be required without the leak ports.

The first microphone port 206 and the second microphone port 208 may each be in communication with one or more microphones within the earcup 104. For instance, the first microphone port 206 may be in communication with a telephony microphone within the earcup 104. Speech or other sound from the user may be conveyed through the first microphone port 206 to the telephony microphone, thereby enabling a user to communicate via the headphone 100. The second microphone port 208 may be in communication with one or more active noise canceling (“ANC”) microphones within the earcup 104. The ANC microphone(s) may detect background noise in the environment around the headphone 100 and the headphone 100 may be configured to produce opposite sound waves to reduce the amount of background noise the user hears.

In order to provide the earcup 104 with a sleek or minimalist aesthetic, the ports 202, 204, 206, 208 may be arranged together within a common recess 210 in the housing 200. The relatively close arrangement of the ports 202, 204, 206, 208 within the common recess 210 can allow for a single decorative cover 212 to be used to cover all of the ports 202, 204, 206, 208, as shown in FIG. 1.

As can be seen, the cover 212 may substantially fill the recess 210 and may have an outer surface that is substantially flush with the outer surface of the housing 200. Additionally, the cover 212 includes a plurality of apertures 214 extending therethrough that allows for air and/or sound waves to pass through the cover 212 and into or out of the ports 202, 204, 206, 208. The cover 212 may be connected to the housing 200 in any suitable manner, including sonic welding, adhesives, mechanical fasteners, friction fit, or combinations thereof.

As can be seen in FIG. 12, the recess 210 may include one or more surface features 216 that extend around the ports 202, 204, 206, 208. In the illustrated embodiment, the surface feature 216 includes a generally triangular shaped ridge, although other shapes are also contemplated.

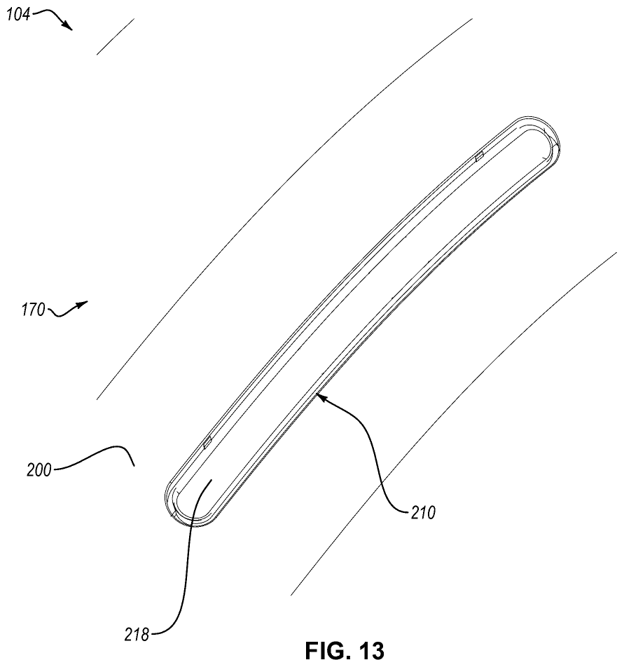

The surface features 216 may be used to secure a mesh layer 218 over the ports 202, 204, 206, 208, as shown in FIG. 13. For instance, the mesh layer 218 may be laid over the ports 202, 204, 206, 208 and the surface features 216. The mesh layer 218 may be secured to the surface features 216 in any suitable manner, such as heat welding, sonic welding, adhesives, mechanical fasteners, or combinations thereof.

The mesh layer 218 may perform multiple functions. For instance, the mesh layer 218 may limit or prevent debris from entering into the ports 202, 204, 206, 208. The mesh layer 218 may also dampen air turbulence around the ports 202, 204, 206, 208. For instance, without the mesh layer 218, air moving over the recess 210 and the ports 202, 204, 206, 208 may create turbulence, which could negatively affect the sound detected by the microphone(s) with the headphone 100. The mesh layer 218, however, can smooth out the flow of air over the ports 202, 204, 206, 208, thereby reducing the turbulence and limiting or avoiding the negative effects of the air movement. To facilitate this functionality of the mesh layer 218, the mesh layer 218 may be positioned relatively close (e.g., less than 1 mm, less than 2 mm, less than 3 mm, etc.) to the outer surface of the housing 200.

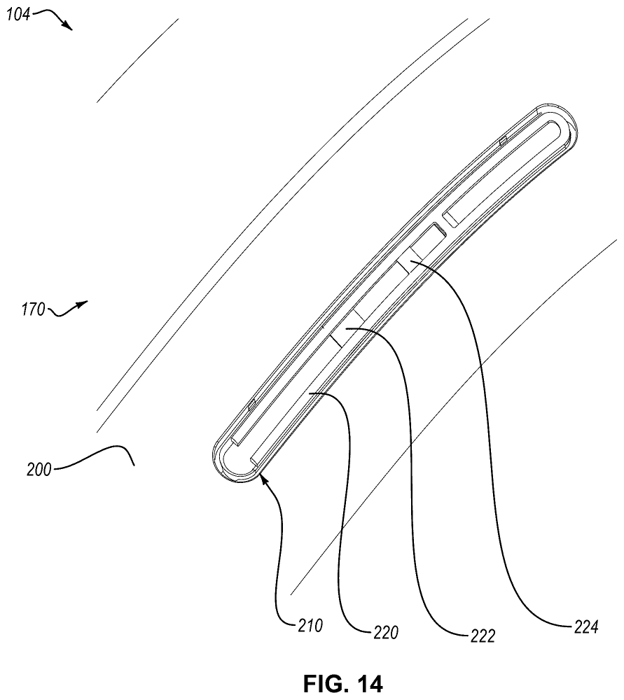

As shown in FIG. 14, one or more gaskets may be used to at least partially isolate all or some of the ports 202, 204, 206, 208 from one another. For instance, a gasket 220 may extend around substantially the entire (or the entire) group of ports 202, 204, 206, 208. Additionally, the gasket 220 may extend between two or more of the ports 202, 204, 206, 208. In the illustrated embodiment, the gasket 220 extends between the first microphone port 206 and the second microphone port 208, such that the first microphone port 206 is entirely surrounded by the gasket 220. Similarly, the gasket 220 or one or more other gaskets (e.g., gaskets 222, 224) may extend between the other ports 202, 204, 206.

Isolating the ports 202, 204, 206, 208 from one another may reduce interference therebetween. For instance, isolating the first microphone port 206 from the front and rear ports 202, 204 may prevent or reduce the likelihood of air or sound waves exiting the ports 202, 204 from entering the first microphone port 206 and creating a feedback loop. Similarly, isolating the second microphone port 208 from the front and rear ports 202, 204 may prevent or reduce the likelihood of air or sound waves exiting the ports 202, 204 from entering the second microphone port 208 and the amount of noise canceling the headphone 100 has to do as a result.

In some embodiments, the gaskets 220, 222, 224 may be cure in place gaskets. Alternatively, the gaskets 220, 222, 224 may be pre-formed and positioned as desired. In some cases, the cover 212 helps hold the gaskets 220, 222, 224 in place. In some embodiments, the gaskets 220, 222, 224 may be positioned over the one or more surface features 216. In other embodiments, the gaskets 220, 222, 224 may be positioned between the surface features 216 and the ports 202, 204, 206, 208.

As noted above, the earcups 104, 106 may include one or more microphones for use in active noise cancellation. In some embodiments, such microphones may include one or more feedforward microphones and one or more feedback microphones. In the earcup 104, the feedforward microphone(s) may be in communication with the second microphone port 208. The feedforward microphone(s) may detect environmental sound outside of the earcup 104 that is desirable to reduce or eliminate for the user. The feedback microphone(s) may detect sound within the earcup 104, such as the sounds adjacent to the user's ear.

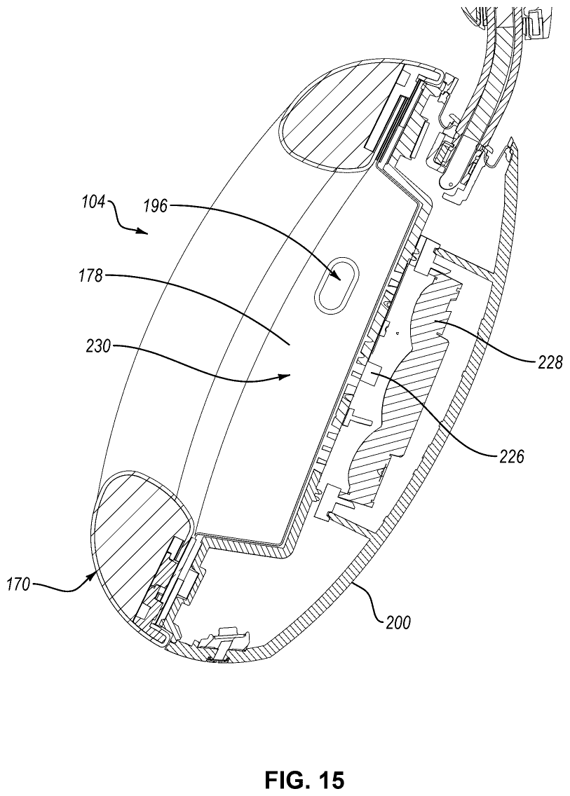

FIG. 15 illustrates one example embodiment of a feedback microphone 226. The placement of the feedback microphone 226 is the illustrated embodiment is unique. Specifically, the feedback microphone 226 is placed in front of the center of a transducer 228 that produces the sound for the user. In the illustrated embodiment, the user's ear fits within a cavity 230 within the earcushion 170. As a result, the feedback microphone 226 is placed directly between the transducer 228 and the user's ear. The feedback microphone 226 can, therefore, detect the sound produced by the transducer 228 and feed that sound back to an active noise cancellation control module, which can further refine the active noise cancellation.

According to one embodiment, a headphone comprises a headband comprising: a frame having a channel extending therethrough; and a cable extending through the channel, the cable being secured to the frame at a center front-and-back and side-to-side of the channel. The headband also includes a first earcup connected to a first end of the headband; and a second earcup connected to a second end of the headband.

In some embodiments, the cable is secured to the frame via one or more retaining features on the frame.

In some embodiments, the cable comprises one or more non-linear segments.

In some embodiments, the one or more non-linear segments comprises a first serpentine segment and a second serpentine segment.

In some embodiments, the frame comprises a plurality of cutouts configured to facilitate bending or flexing of the headband.

In some embodiments, the plurality of cutouts extend at least partially between the front and rear of the frame.

In some embodiments, the headband further comprises a cover plate configured to at least partially cover the plurality of cutouts.

In some embodiments, the cover plate is secured to the frame at or near a middle of the frame, and wherein opposing ends of the cover plate are unsecure from the frame.

In some embodiments, the headband further comprises one or more cushions that cover at least a portion of the frame and the cover plate.

In some embodiments, the one or more cushions comprise a center cushion and first and second lateral cushions.

In some embodiments, the center cushion covers a center region of the frame and the cover plate and the first and second lateral cushions cover lateral regions of the frame and the cover plate.

In some embodiments, the center cushion is formed of a softer material than the first and second lateral cushions.

In some embodiments, the one or more cushions comprise a cushion that covers the center cushion, the first and second lateral cushions, and at least a portion of the frame.

In some embodiments, the headband further comprises a headband spring that is configured to at least partially control the bending or flexing of the headband.

In some embodiments, the headband spring is disposed at least partially within the channel in the frame.

In some embodiments, the headband spring is formed of a plate metal.

In some embodiments, the headband spring comprises one or more slots therein, the one or more slots being configured to receive therethrough one or more fasteners to secure the headband spring to the frame.

In some embodiments, the one or more slots are configured to allow for relative movement between the headband spring and the one or more fasteners as the headband bends or flexes.

In one embodiment, a headphone comprises: a headband; a first earcup connected to a first end of the headband via a first connecting member, a distal end of the first connecting member having a cap; a second earcup connected to a second end of the headband via a second connecting member; and a slider mechanism configured to facilitate adjustment of the first earcup relative to the headband. The slider mechanism comprises: a housing having a channel extending therethrough between upper and lower ends thereof, the channel being configured to receive therein at least a portion of the first connecting member, including the distal end and the cap; and a grommet disposed at least partially within the channel adjacent to a lower end of the channel and around the first connecting member, the grommet being configured to at least partially control the movement of the first connecting member relative to the housing.

In some embodiments, the cap is configured to interact with one or more shoulders within the housing to limit the movement of the first connecting member relative to the housing.

In some embodiments, the cap has an exterior surface that is configured to engage an interior surface of the channel to stabilize movement of the first connecting member relative to the housing.

In some embodiments, the slider mechanism further comprises a bushing extending from the lower end of the housing and configured to have the first connecting member extend through a channel therein.

In some embodiments, the bushing comprises one or more ribs that extend into the channel in the bushing.

In some embodiments, the one or more ribs are flexible.

In some embodiments, the slider mechanism is disposed at least partially within the headband.

In one embodiment, a headphone comprises: a headband; a first earcup connected to a first end of the headband; and a second earcup connected to a second end of the headband. The first earcup comprises: a housing; and an earcushion. The earcushion comprises: a frame assembly; a cushion connected to the frame assembly; and a mesh cage connected to the frame assembly, the mesh cage being contoured to form a cavity configured to receive a user's ear therein, the mesh cage being flexible, resilient, and substantially transparent to sound waves.

In some embodiments, the frame assembly comprises one or more connection elements configured to secure the earcushion to the housing.

In some embodiments, the one or more connection elements comprise one or more magnets.

In some embodiments, the cushion comprises an aperture extending therethrough.

In some embodiments, the mesh cage comprises a first planar portion that is configured to be connected to the frame assembly.

In some embodiments, the mesh cage comprises a second planar portion that is oriented non-parallel to the first planar portion.

In some embodiments, the mesh cage comprises a wall extending between the first planar portion and the second planar portion.

In some embodiments, the wall comprises an aperture extending therethrough.

In some embodiments, the aperture comprises a frame around a perimeter thereof.

In one embodiment, a headphone comprising: a headband; a first earcup connected to a first end of the headband; and a second earcup connected to a second end of the headband. The first earcup comprises a housing having a recess in an outer surface thereof, a plurality of ports being disposed within the recess, the plurality of ports being covered by a mesh layer, and one or more gaskets at least partially surrounding the plurality of ports.

In some embodiments, the plurality of ports comprises one or more leak ports and one or more microphone ports.

In some embodiments, the one or more gaskets extend between the one or more leak ports and the one or more microphone ports.

In some embodiments, the one or more gaskets comprises a cure in place gasket.

In some embodiments, the recess comprises one or more surface features that facilitate connection of the mesh layer over the plurality of ports.

In some embodiments, the one or more gaskets are disposed over the one or more surface features.

In some embodiments, the first earcup further comprises a cover that covers all of the plurality of ports.

In some embodiments, the cover comprises a plurality of apertures extending therethrough.

In some embodiments, the cover fits within and substantially fills the recess.

In one embodiment, a headphone comprises: a headband; a first earcup connected to a first end of the headband; and a second earcup connected to a second end of the headband. The first earcup comprises a housing, a transducer disposed within the housing and configured to produce sound, an ear cushion connected to the housing and configured to be positioned on or receive therein a user's ear, and a feedback microphone disposed within the housing, the feedback microphone being positioned over a center of the transducer and such that the feedback microphone is positioned between the transducer and the user's ear when the headphone is worn.

In some embodiments, the feedback microphone is configured to facilitate active noise cancellation within the first earcup.

### Conclusion

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

1. A headphone comprising:
a headband;
a first earcup connected to a first end of the headband via a first connecting member, a distal end of the first connecting member having a cap;
a second earcup connected to a second end of the headband via a second connecting member; and
a slider mechanism configured to facilitate adjustment of the first earcup relative to the headband, the slider mechanism comprising:
a housing having a channel extending therethrough between an upper end and a lower end thereof, the channel being configured to receive therein at least a portion of the first connecting member, including the distal end and the cap; and
a grommet disposed at least partially within the channel adjacent to a lower end of the channel and around the first connecting member, the grommet being configured to at least partially control movement of the first connecting member relative to the housing.

2. The headphone of claim 1, wherein the cap is configured to interact with one or more structural features within the housing to limit the movement of the first connecting member relative to the housing.

3. The headphone of claim 2, wherein the one or more structural features comprise a shoulder disposed adjacent to the upper end of the housing, the shoulder being configured to interact with the cap to limit how far the first connecting member can be slid into the housing.

4. The headphone of claim 2, wherein the one or more structural features comprise the grommet or a shoulder adjacent to the lower end of the housing, the grommet or the shoulder being configured to interact with the cap to limit how far out of the housing the first connecting member can be slid.

5. The headphone of claim 1, wherein the cap has an exterior surface that is configured to engage an interior surface of the channel to stabilize movement of the first connecting member relative to the housing.

6. The headphone of claim 5, wherein the exterior surface of the cap has an outer shape and/or a dimension that generally corresponds to a shape and/or inner dimension of the channel.

7. The headphone of claim 1, wherein the slider mechanism further comprises a bushing extending from the lower end of the housing and configured to have the first connecting member extend through a channel therein.

8. The headphone of claim 7, wherein the bushing comprises one or more ribs that extend into the channel in the bushing.

9. The headphone of claim 8, wherein the one or more ribs are configured to interface with the first connecting member.

10. The headphone of claim 9, wherein interfaces between the cap and the channel within the housing, the grommet and the first connecting member, and the one or more ribs and the first connecting member are spaced apart from one another along a length of the first connecting member.

11. The headphone of claim 8, wherein the one or more ribs are flexible.

12. The headphone of claim 7, wherein the grommet is disposed between the cap and the bushing.

13. The headphone of claim 1, wherein the slider mechanism is disposed at least partially within the headband.

14. The headphone of claim 1, wherein the grommet has an inner dimension that is smaller than an interior dimension of the channel.

15. The headphone of claim 1, wherein the first connecting member has an outer dimension that is smaller than an outer dimension of the cap and an inner dimension of the channel.

16. A headphone comprising:
a headband;
an earcup connected to a first end of the headband via a connecting member; and
a slider mechanism configured to facilitate adjustment of the earcup relative to the headband, the slider mechanism comprising:
a housing having a channel extending therethrough between upper and lower ends thereof, the channel being configured to receive therein at least a portion of the connecting member, including a distal end thereof;
a grommet disposed at least partially within the channel adjacent to a lower end of the channel and around the connecting member, the grommet being configured to at least partially control movement of the connecting member relative to the housing; and
a bushing extending from the lower end of the housing and configured to have the connecting member extend through a channel therein, interaction between the bushing and the connecting member being configured to at least partially control movement of the connecting member relative to the housing.

17. The headphone of claim 16, wherein the bushing comprises one or more ribs that extend into the channel in the bushing and engage the connecting member.

18. The headphone of claim 16, wherein the distal end of the connecting member comprises a cap, the cap being configured to engage the channel in the housing to stabilize movement of the connecting member relative to the housing.

19. The headphone of claim 16, wherein the connecting member has an outer dimension that is smaller than an inner dimension of the channel.

20. A headphone comprising:
a headband;
an earcup connected to a first end of the headband via a connecting member, a distal end of the connecting member having a cap; and
a slider mechanism configured to facilitate adjustment of the earcup relative to the headband, the slider mechanism comprising:
a housing having a channel extending therethrough between upper and lower ends thereof, the channel being configured to receive therein at least a portion of the connecting member, including the distal end and the cap, interaction between the cap and the channel being configured to at least partially control movement of the connecting member relative to the housing;
a grommet disposed at least partially within the channel adjacent to a lower end of the channel and around the connecting member, the grommet being configured to at least partially control movement of the connecting member relative to the housing; and
a bushing extending from the lower end of the housing and configured to have the connecting member extend through a channel therein, interaction between the bushing and the connecting member being configured to at least partially control movement of the connecting member relative to the housing,
wherein interfaces between the cap and the channel within the housing, the grommet and the connecting member, and the bushing and the connecting member are spaced apart from one another along a length of the connecting member.
